(19) United States
(12) Patent Application Publication
(10) Pub. No.: US 2014/0313625 A1
(43) Pub. Date: Oct. 23, 2014

(54) VOLTAGE PROTECTION CIRCUIT

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: HAI-QING ZHOU, Shenzhen (CN); YI-XIN TU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/252,882

(22) Filed: Apr. 15, 2014

(30) Foreign Application Priority Data
Apr. 19, 2013 (CN) 2013101371678

(51) Int. Cl. H02H 3/24

(52) U.S. Cl. CPC H02H 3/24
USPC 361/86

(57) ABSTRACT

A voltage protection circuit includes a first power source, a power circuit, a comparator, and a electronic switch. The power circuit provides an output voltage to the comparator. The comparator compares the output voltage with a reference voltage. The electronic switch controls the power circuit according to the comparison. When the output voltage is larger than the reference voltage, the electronic switch controls the power circuit to stop providing the output voltage.

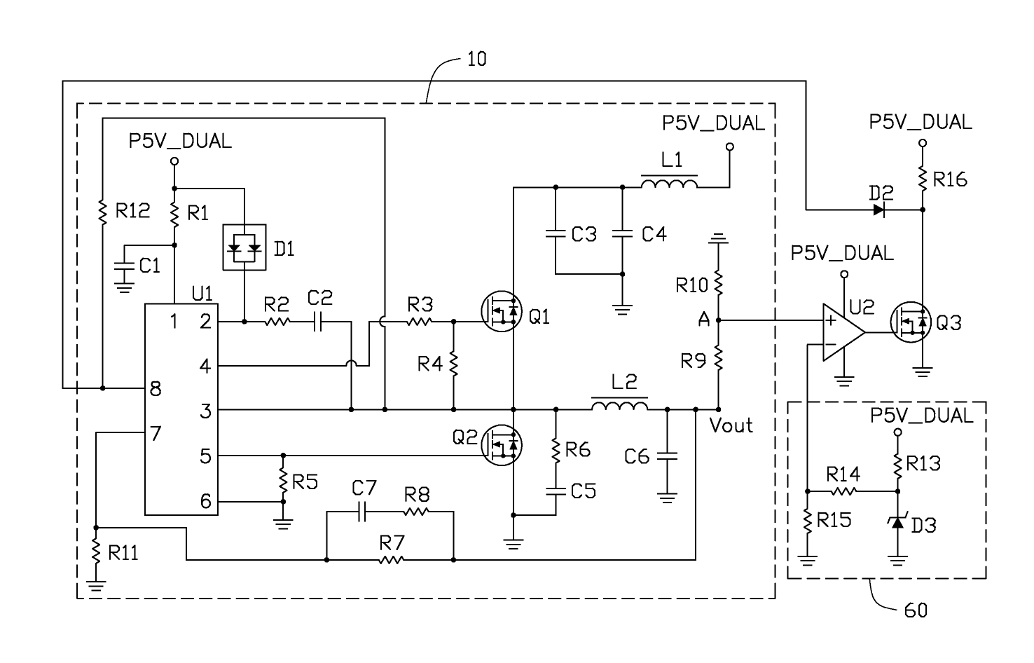

### FIELD

The present disclosure relates to a voltage protection circuit.

### BACKGROUND

Working voltages within an operating voltage range allow electronic components to have stable performance. If working voltages are beyond the range, the components may be damaged or destroyed.

Therefore, there is need for improvement in the art.

### BRIEF DESCRIPTION OF THE DRAWINGS

Many aspects of the present disclosure can be better understood with reference to the following drawing. The components in the drawing are not necessarily drawn to scale, the emphasis instead being placed upon clearly illustrating the principles of the present disclosure.

The FIGURE is a circuit diagram of an embodiment of a voltage protection circuit of the present disclosure.

### DETAILED DESCRIPTION

The disclosure, including the drawing, is illustrated by way of example and not by way of limitation. References to “an” or “one” embodiment in this disclosure are not necessarily to the same embodiment, and such references mean at least one.

As shown in the figure, a voltage protection circuit in an embodiment of the present disclosure comprises a power circuit 10, a comparator U2, an electronic switch Q3, a reference voltage circuit 60, a resistor R16, and a diode D2. The power circuit 10 comprises a control chip U1, a diode unit D1, two electronic switches Q1 and Q2, two inductors L1 and L2, seven capacitors C1-C7, and twelve resistors R1-R12. The reference voltage circuit 60 comprises a diode D3 and three resistors R13-R15. In the embodiment, each of the electronic switches Q1-Q3 comprises a first terminal, a second terminal, and a third terminal. The control chip U1 comprises a power supply pin 1, a boot pin 2, a phase pin 3, a first gate pin 4, a second gate pin 5, a ground pin 6, a feedback pin 7, and a control pin 8. In addition, the diode D3 is a zener diode.

The power supply pin 1 is grounded through the capacitor C1 and is connected to a power source P5V_DUAL through the resistor R1. The power source P5V_DUAL is connected to an anode of the diode unit D1. The boot pin 2 is connected to a cathode of the diode unit D1. The boot pin 2 is connected to the phase pin 3 through the resistor R2 and the capacitor C2. The first gate pin 4 is connected to the first terminal of the electronic switch Q1 through the resistor R3. The second terminal of the electronic switch Q1 is connected to the power source P5V_DUAL through the inductor L1. The second terminal of the electronic switch Q1 is grounded through the capacitor C3 and through the capacitor C4. The first terminal of the electronic switch Q1 is connected to the third terminal of the electronic switch Q1 through the resistor R4, and the third terminal of the electronic switch Q1 is connected to the phase pin 3.

The third terminal of the electronic switch Q1 is connected to the second terminal of the electronic switch Q2. The second gate pin 5 is connected to the first terminal of the electronic switch Q2. The first terminal of the electronic switch Q2 is connected to the ground pin 6 through the resistor R5. The ground pin 6 is grounded. The third terminal of the electronic switch Q2 is grounded and is connected to the second terminal of the electronic switch Q2 through the capacitor C5 and the resistor R6. The second terminal of the electronic switch Q2 is grounded through the inductor L2 and the capacitor C6. A node between the inductor L2 and the capacitor C6 is an output end Vout for providing working voltages to electronic components grounded through the resistors R9 and R10. The node between the inductor L2 and the capacitor C6 is connected to the feedback pin 7 through the resistor R7 and through the resistor R8 and the capacitor C7. The node between the inductor L2 and the capacitor C6 is grounded through the resistors R7 and R11. The control pin 8 is connected to the phase pin 3 through the resistor R12. The control pin 8 is connected to an anode of the diode D2.

A cathode of the diode D3 is connected to the power source P5V_DUAL through the resistor R13. An anode of the diode D3 is grounded. The cathode of the diode D3 is also grounded through the resistors R14 and R15. A node between the resistors R14 and R15 is connected to a non-inverting input terminal of the comparator U2 to provide a reference voltage to the comparator U2. A node between the resistors R9 and R10 is connected to an inverting input terminal of the comparator U2 through an output terminal A of the power circuit 10. A power terminal of the comparator U2 is connected to the power source P5V_DUAL. A grounded terminal of the comparator U2 is grounded. An output terminal of the comparator U2 is connected to the first terminal of the electronic switch Q3. The second terminal of the electronic switch Q3 is connected to the power source P5V_DUAL through a resistor R16, and is connected to a cathode of the diode D2. The third terminal of the electronic switch Q3 is grounded.

In the embodiment shown in the figure, the boot pin 2 of the control chip U1 provides an offset voltage to the electronic switch Q1. The phase pin 3 of the control chip U1 is connected to the third terminal of the electronic switch Q1 and to the second terminal of the electronic switch Q2 to detect any voltage drop of the electronic switch Q2, to provide over-current protection. The first gate pin 4 provides a first pulse-width modulation (PWM) signal to drive the electronic switch Q1. The second gate pin 5 provides a second PWM signal to drive the electronic switch Q2.

In the embodiment shown in the figure, the feedback pin 7 of the control chip U1 is connected to an internal comparator of the control chip U1. When a received voltage of the feedback pin 2 is fixed, the resistance of the resistors R7 and R11 determine the voltage of the output end Vout.

An operating principle of the embodiment of the present disclosure is as follows.

When the control chip U1 operates, the first gate pin 4 and the second gate pin 5 of the control chip U1 alternately output high level signals, such as logic 1, and low level signals, such as logic 0. When the first gate pin 4 outputs a high level signal and the second gate pin 5 outputs a low level signal, the electronic switch Q1 is turned on and the electronic switch Q2 is turned off The power source P5V_DUAL charges the inductor L2 and the capacitor C6 through the electronic switch Q1. When the first gate pin 4 outputs a low level signal and the second gate pin 5 outputs a high level signal, the electronic switch Q1 is turned off and the electronic switch Q2 is turned on. The inductor L2 and the capacitor C6 discharge through the electronic switch Q2. Accordingly, the voltage of the output end Vout is rendered to be stable. The voltage of the output terminal A of the power circuit 10 is a ratio of the voltage of the output end Vout according to resistance of the resistors R9 and R10.

When the voltage of the output terminal A is larger than the reference voltage, the electronic switch Q3 is turned on and the diode D2 is turned on, and the control pin 8 of the control chip U1 receives a low level signal. Thus, the control chip U1 stops and there is no voltage output from the output end Vout, for overvoltage protection.

When the voltage of the output terminal A is smaller than the reference voltage, the electronic switch Q3 is turned off and the diode D2 is turned off. Then, the control pin 8 of the control chip U1 receives a high level signal so that the control chip U1 keeps working and the voltage of the output end Vout is stable. When a current of the phase pin 3 is too large, a high voltage drop on the resistor 12 and the control pin 8 of the control chip U1 receives a low level signal. Thus, the control chip U1 stops and there is no voltage output from the output end Vout, for over-current protection.

The diode D2 is utilized to isolate the power source P5V_DUAL, to avoid the power source P5V_{—DUAL} through the resistor R16 affecting the over-current protection.

In the embodiment, each of the electronic switches Q1-Q3 is a transistor, such as a bipolar junction transistor (BJT) or a field-effect transistor (FET). When the electronic switch is the BJT, the first terminal of the electronic switch is a base, the second terminal of the electronic switch is a collector, and the third terminal of the electronic switch is an emitter. When the electronic switch is the FET, the first terminal of the electronic switch is a gate, the second terminal of the electronic switch is a drain, and the third terminal of the electronic switch is a source. In addition, the diode D3 is functioning as voltage stabilizer. In other embodiments, the diode D3 can be replaced by other voltage stabilizer elements.

The voltage protection circuit compares the voltage of the output terminal A with the reference voltage by the comparator. When the voltage of the output terminal A is larger than the reference voltage, the control chip U1 stops and there is no voltage output from the output end Vout. When the voltage of the output terminal A is smaller than the reference voltage and the current of the phase pin 3 is too large, the control chip U1 stops and no voltage output from the output end Vout. Damage to the electronic components powered by the voltage of the output end Vout is thus avoided.

While the disclosure has been described by way of example and in terms of various embodiments, it is to be understood that the disclosure is not limited thereto. On the contrary, it is intended to cover various modifications and similar arrangements as would be apparent to those skilled in the art. Therefore, the range of the appended claims should be construed to encompass all such modifications and similar arrangements.

What is claimed is:

1. A voltage protection circuit comprising:
a power circuit and comprising a control pin and a output terminal;
a reference voltage circuit outputting a reference voltage;
a comparator comprising a non-inverting input terminal connected to the output terminal of the power circuit, an inverting input terminal receiving the reference voltage, and an output terminal; and
a first electronic switch comprising a first terminal connected to the output terminal of the comparator, a second terminal connected to the control pin of the power circuit, and a third terminal;
wherein when the output terminal of power circuit is lower than the reference voltage, the electronic switch is turned off, the control pin receives a high level signal, the power circuit outputs a stable working voltage to power electronic components; when the output terminal of power circuit is higher than the reference voltage, the electronic switch is turned on, the control pin receives a low level signal, and the power circuit stops outputting voltage.

2. The voltage protection circuit of claim 1, wherein the second terminal of the first electronic switch is connected to a power source through a first resistor, and the third terminal of the first electronic switch is grounded.

3. The voltage protection circuit of claim 2, wherein a first diode isolated a voltage signal, wherein the first diode comprises a cathode connected to the second terminal of the first electronic switch, and an anode connected to the control pin of the power circuit.

4. The voltage protection circuit of claim 1, wherein the first electronic switch is a bipolar junction transistor (BJT), the first terminal of the BJT is a base, the second terminal of the BJT is a collector, and the third terminal of the BJT is an emitter.

5. The voltage protection circuit of claim 1, wherein the first electronic switch is a field-effect transistor (FET), the first terminal of the FET is a gate, the second terminal of the FET is a drain, and the third terminal of the FET is a source.

6. The voltage protection circuit of claim 1, wherein the reference voltage circuit comprises a first diode, first to third resistors, a cathode of the first diode is connected to the power source through the first resistor, an anode of the first diode is grounded, the cathode of the first diode is also grounded through the second and the third resistors, and a node between the second and the third resistors is connected to the non-inverting input terminal of the comparator.

7. The voltage protection circuit of claim 1, wherein the power circuit comprises an output end for outputting the working voltage, a first resistor and a second resistor are connected in series between the output end and ground, and the non-inverting input terminal of the comparator is connected to a node between the first resistor and the second resistor as the output terminal.

8. The voltage protection circuit of claim 1, wherein the power circuit comprises:
a control chip comprising a power supply pin, a boot pin, a phase pin, a first gate pin, a second gate pin, a ground pin, a feedback pin, and a control pin;
first to fourth resistors; a first inductor; first and second capacitors;
a diode unit; and
a first and a second electronic switches, each of the first and a second electronic switches comprises a first, a second and a third terminals;
wherein the power supply pin is connected to the power source, the power source is connected to an anode of the diode unit, the boot pin is connected to a cathode of the diode unit, the boot pin is connected to the phase pin through the first resistor and the first capacitor, the first gate pin is connected to the first terminal of the first electronic switch, the second terminal of the first electronic switch is connected to the power source, the first terminal of the first electronic switch is connected to the third terminal of the first electronic switch, and the third terminal of the first electronic switch is connected to the phase pin, the third terminal of the first electronic switch is connected to the second terminal of the second electronic switch, the second gate pin is connected to the first terminal of the second electronic switch, the first terminal of the second electronic switch is connected to the ground pin through the second resistor, the ground pin is grounded, the third terminal of the second electronic switch is grounded and connected to the second terminal of the second electronic switch, the second terminal of the second electronic switch is grounded through the first inductor and the second capacitor, a node between the first inductor and the second capacitor is grounded through the third and the fourth resistors, and the node between the third and the fourth resistor is connected to the feedback pin.

9. The voltage protection circuit of claim 8, wherein the power circuit further comprises a third capacitor and a fifth resistor, the power supply pin of the control chip is grounded through the third capacitor and is connected to the power source through the fifth resistor.

10. The voltage protection circuit of claim 9, wherein the power circuit further comprises a second inductor, a fourth and a fifth capacitor, the first terminal of the first electronic switch is connected to the power souse through the second inductor, and grounded through the fourth capacitor and through the fifth capacitor.

11. The voltage protection circuit of claim 10, wherein the power circuit further comprises a sixth resistor and a sixth capacitor, the second terminal of the second electronic switch is grounded through the sixth resistor and the sixth capacitor.

12. The voltage protection circuit of claim 11, wherein the power circuit further comprises a seventh resistor and a seventh capacitor, the node between the first inductor and the second capacitor is connected to the feedback pin of the control chip through the seventh resistor and the seventh capacitor.

13. The voltage protection circuit of claim 12, wherein the power circuit further comprises a twelfth and a eighteen resistors, the first gate pin of the control chip is connected to the first terminal of the first electronic switch through the eighteen resistor, and the first terminal of the first electronic switch is connected to the phase pin of the control chip through the eighteen resistor.

14. The voltage protection circuit of claim 13, wherein the power circuit further comprises a ninth resistor, the phase pin of the control chip is connected to the control pin of the control chip through the ninth resistor.

15. The voltage protection circuit of claim 4, wherein the first and second electronic switches are bipolar junction transistors (BJTs), each of the first terminals of the BJTs is a base, each of the second terminals of the BJTs is a collector, and each of the third terminals of the BJTs is an emitter.

16. The voltage protection circuit of claim 4, wherein the first and second electronic switches are field-effect transistors (FETs), each of the first terminals of the FETs is a gate, each of the second terminals of the FETs is a drain, and each of the third terminals of the FETs is a source.
